(19) United States
(12) Patent Application Publication
(10) Pub. No.: US 2025/0373829 A1
(43) Pub. Date: Dec. 4, 2025

(54) FILTER DESIGN FOR SIGNAL ENHANCEMENT FILTERING FOR REFERENCE PICTURE RESAMPLING

(71) Applicant: GUANGDONG OPPO MOBILE TELECOMMUNICATIONS CORP., LTD., Dongguan (CN)

(72) Inventors: Tim CLASSEN, Dongguan (CN); Mathias WIEN, Dongguan (CN)

(21) Appl. No.: 19/302,194

(22) Filed: Aug. 18, 2025

Related U.S. Application Data
(63) Continuation of application No. PCT/CN2023/077257, filed on Feb. 20, 2023.

(51) Int. Cl. H04N 19/33; H04N 19/176; H04N 19/80

(52) U.S. Cl. CPC H04N 19/33; H04N 19/176; H04N 19/80

(57) ABSTRACT

A method of processing video data performed by a decoder includes: decoding a bitstream to obtain video data and coding information, the coding information comprising weighting map indication information for defining a weighting map and filter coefficients optimized for the weighting map; obtaining a picture block based on the video data; upsampling the picture block; determining the weighting map using the weighting map indication information; and obtaining an enhanced picture block by applying a signal enhancement filter using the filter coefficients, together with the weighting map, to the upsampled picture block.

### CROSS-REFERENCE TO RELATED APPLICATIONS

This application is a continuation of International Application No. PCT/CN2023/077257 filed on Feb. 20, 2023, which is incorporated herein by reference.

### TECHNICAL FIELD

The present application relates to the field of computer vision, in particular to the topic of video processing and video coding, more particularly to a method, a decoder, an encoder, and a computer-readable medium for filter design for signal enhancement filtering for reference picture resampling.

### BACKGROUND

Current video coding schemes such as H.265/HEVC (High Efficiency Video Coding) and H.266/VVC (Versatile Video Coding) support spatial scalability of the coded video stream. This support for spatial scalability was included in the second version of HEVC with the scalability extension SHVC while VVC natively supports spatial scalability. Adaptively changing the resolution of the coded video during coding is known from VVC as reference picture resampling (RPR) or adaptive resolution change (ARC). Moreover, multiple-resolution coding and multi-layer coding allows for a scalable resolution of the coded video. For that reason, the spatial resolution at which a video is coded may change adaptively and no longer needs to be equivalent to the output or input resolution of the video. The advantages of this additional flexibility are that coding a lower resolution video requires a lower bitrate and may reduce computational complexity at the cost of losing high frequency information in the downsampling step.

Coding a video at lower resolution than its original resolution requires a downsampling and an upsampling step in the signal processing chain. In the downsampling step, an anti-aliasing filter is applied to prevent artifacts caused by high frequency components in the image. The upsampling process applies interpolation filters to reconstruct the intensity values at fractional sample positions.

In RPR, the resolution of the coded video stream may change adaptively. Consequently, the encoder may code parts of the video stream at lower resolution. RPR is applied in the inter-prediction every time that a picture uses a reference picture of different resolution than the current picture in inter prediction. In this step, a resampling operation needs to be applied such that the referenced picture block is mapped to the same spatial resolution as the current picture.

In multi-layer coding, the video is coded at different resolution layers. In a first step, the video is coded at the lowest resolution layer. To generate the video stream of the next layer, the video is upsampled and, potentially, a residual is coded and further processing steps are applied. This process may be applied multiple times based on the number of layers.

Finding an optimal high-resolution representation from the low-resolution picture is an important part of the above-mentioned coding schemes. One method is to apply a set of multi-phase Finite Impulse Response (FIR)-interpolation filters. While those filters do provide an approximation of the high-resolution image content, they cannot recover information that was lost in the downsampling process and suffer from limitations of the linear filtering operation. Consequently, upsampled images are often blurred.

An image sharpening operation can increase the picture quality. However, linear high-pass filters frequently cause artifacts such as overshoot and ringing. Moreover, the distortions caused by the down-and upsampling depend on the image content and the coding quality of the video (influenced by the Quantization Parameter (QP) value).

### SUMMARY

Embodiments of the present application provide a method, a decoder, an encoder, and a computer-readable medium for video coding using signal enhancement filtering.

According to a first aspect, a method of processing video data, performed by a decoder, is provided. The method comprises decoding a bitstream to obtain video data and coding information, the coding information comprising weighting map indication information for defining a weighting map and filter coefficients optimized for the weighting map; obtaining a picture block based on the video data; upsampling the picture block; determining the weighting map using the weighting map indication information; and obtaining an enhanced picture block by applying a signal enhancement filter using the filter coefficients, together with the weighting map, to the upsampled picture block.

In some embodiments the weighting map comprises a scalar weighting map.

In some embodiments the weighting map comprises a Sobel magnitude map.

In some embodiments the weighting map comprises a plurality of weighting values respectively corresponding to values in the upsampled picture block.

In some embodiments signal enhancement filter indication information indicates to re-use one or more filter coefficients stored in a filter buffer of the decoder for the signal enhancement filter.

In some embodiments determining the weighting map using the weighting map indication information comprises: determining a weighting map function using the weighting map indication information; and calculating the weighting map by applying the weighting map function to the upsampled picture block.

In some embodiments the weighting map indication information comprises a weighting map identifier identifying one among a plurality of predefined weighting map functions.

In some embodiments the weighting map indication information comprises parameters for the weighting map function.

In some embodiments the picture block is a prediction block, and where obtaining the picture block based on the video data comprises performing a prediction operation using the video data to obtain the prediction block.

In some embodiments the prediction operation is inter-prediction or intra-prediction.

In some embodiments the picture block is a reference sample, and the method further comprises performing a prediction operation using the enhanced reference sample to obtain a prediction block.

In some embodiments the prediction operation comprises inter-prediction, the reference sample corresponds to a first picture of the video data coded in the bitstream, the prediction block corresponds to a second picture of the video data coded in the bitstream, the second picture being temporally spaced from the first picture, and the first picture is coded at a lower resolution than the second picture in the bitstream.

In some embodiments the coding information indicates to apply a plurality of filters with a plurality of respective weighting maps to the picture block.

In some embodiments the coding information indicates to use different weighting maps and/or signal enhancement filters for different picture blocks of a picture.

According to a second aspect, a non-transitory computer-readable medium is provided which comprises computer executable instructions stored thereon which when executed by a computing device cause the computing device to perform any of the methods in relation to the first aspect.

According to a third aspect, a computer-implemented method of processing video data, performed by a decoder, is provided. The method comprises decoding a bitstream to obtain video data and coding information, the coding information comprising weighting map indication information; obtaining a picture block based on the video data; upsampling the picture block; determining a weighting map using the weighting map indication information; and obtaining an enhanced picture block by applying a signal enhancement filter, together with the weighting map, to the upsampled picture block such that the signal enhancement filter is applied with different weights to different regions of the picture block.

In some embodiments, the signal enhancement filter comprises a Wiener filter.

In some embodiments, the weighting map comprises a plurality of weighting values respectively corresponding to values in the upsampled picture block.

In some embodiments, the coding information further comprises signal enhancement filter indication information, and the method further comprises: decoding the bitstream to determine the signal enhancement filter.

In some embodiments, filter parameters of the signal enhancement filter are explicitly signaled in the bitstream or are derived by the decoder from video data in the bitstream.

In some embodiments, the signal enhancement filter indication information indicates to re-use one or more filter parameters stored in a filter buffer of the decoder for the signal enhancement filter.

In some embodiments, determining the weighting map using the weighting map indication information comprises: determining a weighting map function using the weighting map indication information; and calculating the weighting map by applying the weighting map function to the upsampled picture block.

In some embodiments, the weighting map indication information comprises a weighting map identifier identifying one among a plurality of predefined weighting map functions.

In some embodiments, the weighting map indication information comprises parameters for the weighting map function.

In some embodiments, the picture block is a prediction block, and obtaining the picture block based on the video data comprises performing a prediction operation using the video data to obtain the prediction block.

In some embodiments, the prediction operation is inter-prediction or intra-prediction.

In some embodiments, a residual is encoded into the bitstream at a resolution of the upsampled picture block; and where the method further comprises: decoding the bitstream to determine the residual, and applying the residual to the enhanced prediction block.

In some embodiments, the picture block is a reference sample, and the method further comprises performing a prediction operation using the enhanced reference sample to obtain a prediction block.

In some embodiments, the prediction operation comprises inter-prediction, the reference sample corresponds to a first picture of the video data coded in the bitstream, the prediction block corresponds to a second picture of the video data coded in the bitstream, the second picture being temporally spaced from the first picture, and the first picture is coded at a lower resolution than the second picture in the bitstream.

In some embodiments, the coding information indicates to apply a plurality of filters with a plurality of respective weighting maps to the picture block.

In some embodiments, the coding information indicates to use different weighting maps and/or signal enhancement filters for different picture blocks of a picture.

According to a fourth aspect, a non-transitory computer-readable medium is provided. The computer-readable medium comprises computer executable instructions stored thereon which when executed by a computing device cause the computing device to perform any of the methods discussed in relation to the third aspect.

According to a fifth aspect, a decoder is provided. The decoder comprises one or more processors; and a non-transitory computer-readable medium comprising computer executable instructions stored thereon which when executed by the one or more processors cause the one or more processors to perform any of the methods discussed in relation to the third aspect.

According to a sixth aspect, a method of processing video data, performed by an encoder, is provided. The method comprises obtaining original video data;

obtaining a downsampled version of the original video data; obtaining a picture block based on the downsampled original video data; upsampling the picture block;

obtaining a weighting map from the original video data; defining a linear equation which represents a signal enhancement filter which calculates an enhanced picture block based on the weighting map, filter coefficients and the upsampled picture block; applying least-squares optimization on the linear equation to obtain optimal filter coefficients for the weighting map; obtaining an enhanced picture block by applying the signal enhancement filter using the optimal filter coefficients, together with the weighting map, to the upsampled picture block; and encoding the downsampled original video data and coding information into a bitstream, the coding information comprising weighting map indication information indicating the weighting map and the calculated filter coefficients.

In some embodiments the filter coefficients are calculated by calculating partial derivatives which are set to zero.

In some embodiments the linear equation is brought into a form of a matrix vector multiplication, where the matrix is a symmetric matrix.

In some embodiments the upsampled picture block is an upsampled low resolution picture block which occurs after reference picture upsampling or multi-resolution coding.

In some embodiments the weighting map comprises a scalar weighting map. In some embodiments the weighting map comprises a Sobel magnitude map.

In some embodiments the weighting map comprises a plurality of weighting values respectively corresponding to values in the upsampled picture block.

In some embodiments the weighting map indication information and the calculated filter coefficients are quantized and entropy encoded.

In some embodiments the weighting map indication information and the calculated filter coefficients are explicitly signalled in the bitstream or are to be derived by a decoder from the video data in the bitstream.

In some embodiments the weighting map is obtained by: determining a weighting map function using weighting map indication information; and calculating the weighting map by applying the weighting map function to the upsampled picture block.

In some embodiments the weighting map indication information comprises a weighting map identifier identifying one among a plurality of predefined weighting map functions.

In some embodiments the weighting map indication information comprises parameters for the weighting map function.

In some embodiments the picture block is a prediction block, and obtaining the picture block based on the downsampled original video data comprises performing a prediction operation using the original video data to obtain the prediction block.

In some embodiments the prediction operation is inter-prediction or intra-prediction.

In some embodiments, the picture block is a reference sample, and the method further comprises performing a prediction operation using the enhanced reference sample to obtain a prediction block.

In some embodiments the prediction operation comprises inter-prediction, the reference sample corresponds to a first picture of the video data coded in the bitstream, the prediction block corresponds to a second picture of the video data coded in the bitstream, the second picture being temporally spaced from the first picture, and the first picture is coded at a lower resolution than the second picture in the bitstream.

In some embodiment the coding information indicates to apply a plurality of filters with a plurality of respective weighting maps to the picture block.

In some embodiments the coding information indicates to use different weighting maps and/or signal enhancement filters for different picture blocks of a picture.

According to a seventh aspect, a non-transitory computer-readable medium is provided, which comprises computer executable instructions and a bitstream stored thereon, the instructions which when executed by a processor of a computing device, cause the computing device to perform any of the method of in relation to the sixth aspect to generate the bitstream.

According to an eighth aspect, an encoder is provided which comprises one or more processors; and a non-transitory computer-readable medium comprising computer executable instructions stored thereon which when executed by the one or more processors cause the one or more processors to perform any of the methods in relation to the sixth aspect.

These and other aspects of the present application may become more readily apparent from the following description of the embodiments.

### BRIEF DESCRIPTION OF THE DRAWINGS

Embodiments will now be described, by way of example only, with reference to the accompanying drawings, in which:

FIG. 1A shows a flowchart of the operations of a decoder according to a first embodiment;

FIG. 1B shows a flowchart of the operations of an encoder according to the first embodiment;

FIG. 2A shows a block diagram illustrating example operations of the decoder according to a variant of the first embodiment;

FIG. 2B shows a block diagram illustrating example operations of the encoder according to the variant of the first embodiment;

FIG. 3 shows a schematic illustration of a decoder according to various embodiments; and

FIG. 4 shows a schematic illustration of an encoder according to various embodiments.

### DETAILED DESCRIPTION

Technical solutions in the embodiments of the present application will be described clearly and completely below with reference to the accompanying drawings.

These technical solutions may be applied to a H.265/HEVC or H.266/VVC video coding system, particularly in the performance of RPR, ARC, multiple-resolution coding, and multi-layer coding. However, it is to be understood that these technical solutions may be applied in any other video coding system that involves upsampling. Furthermore, while these principles are primarily illustrated with reference to video processing, they are also applicable to other data forms, including image processing or even audio processing.

A “video” in the embodiments refers to one or more pictures. In other words, a video can include one picture or a plurality of pictures. A picture may also be referred to as an “image”.

An “encoder” is a device capable of encoding data into a bitstream, while a “decoder” is a device capable of decoding the bitstream in order to obtain the encoded data. A “bitstream” comprises a sequence of bits.

“Intra-prediction” and “inter-prediction” are two prediction operations that can be used within the HEVC and VVC frameworks for a decoder to process a received bitstream in order to obtain the original signal. In the embodiments, “original signal” or “original video” is used to refer to the data prior to encoding at the encoder. A reference sample in the embodiments may refer to spatially and/or temporally spaced picture data used for the prediction of a picture (or region of a picture).

In more detail, intra-prediction involves the prediction of data spatially within a single picture, without a reference to other (temporally spaced) pictures. In other words, data for a first region of a picture picture is used in the prediction of the data for another region of the same picture picture, but there is no dependence on another picture from another picture. In this context, the data for the first region of the picture picture is considered a “reference sample”.

Inter-prediction involves the prediction of data between a plurality of pictures. In other words, data for a first region of a first picture picture is used in the prediction of data for a second region of a second picture picture. The first and second region may or may not be spatially separated from one another. In this context, the data for the first region of the first picture picture is considered a “reference sample”.

A “weighting map” is a map or a mask which contains scalar weights which indicate the intensity or strength with which a filter is to be applied to a position (e.g. sample) of a picture. It is assumed that weighting of an adaptive loop filter by a suitable sample-wise mask leads to a more precise filter decision and therefore a higher quality of the filter picture. This is helpful as linear filters usually have trade-off between the edge steepness after sharpening and the overshoot and ringing artifacts. Having an amplification of the filter at the steepest points of the edge could reduce such problems.

A “residual” in the embodiments may refer to value obtained based on an original value of a region of a picture and a prediction value of the region of the picture (e.g. the difference between the original value and the predicted value).

A “block” in the embodiments may refer to a portion of a picture. For example, a picture may be portioned into two or more blocks. However, this only an example. If a picture is not partitioned, then a “block” can refer to the entire picture.

A “signal enhancement filter” may refer to a filter that acts to enhance a signal, particularly an upsampled signal. In general, in the described embodiments, the signal enhancement filter is a filter configured to reduce edge blurring (i.e. to sharpen a picture block). However, embodiments are not limited to this and the signal enhancement filter can instead be configured to provide alternative or additional signal enhancements in other embodiments, such as removing blocking artifacts and/or ringing artifacts.

In a first clause, a method of processing video data performed by a decoder is provided. The method includes:
decoding a bitstream to obtain video data and coding information, the coding information comprising weighting map indication information for defining a weighting map and filter coefficients optimized for the weighting map;
obtaining a picture block based on the video data;
upsampling the picture block;
determining the weighting map using the weighting map indication information; and
obtaining an enhanced picture block by applying a signal enhancement filter using the filter coefficients, together with the weighting map, to the upsampled picture block.

In a second clause, according to the first clause, the weighting map includes a scalar weighting map.

In a third clause, according to the first clause or the second clause, the weighting map includes a Sobel magnitude map.

In a fourth clause, according to any one of the first clause to the third clause, the weighting map includes a plurality of weighting values respectively corresponding to values in the upsampled picture block.

In a fifth clause, according to any one of the first clause to the fourth clause, the signal enhancement filter indication information indicates to re-use one or more filter coefficients stored in a filter buffer of the decoder for the signal enhancement filter.

In a sixth clause, according to any one of the first clause to the fifth clause, determining the weighting map using the weighting map indication information includes:
determining a weighting map function using the weighting map indication information; and
calculating the weighting map by applying the weighting map function to the upsampled picture block.

In a seventh clause, according to the sixth clause, the weighting map indication information includes a weighting map identifier identifying one among a plurality of predefined weighting map functions.

In an eighth clause, according to the sixth clause or the seventh clause, the weighting map indication information includes parameters for the weighting map function.

In a ninth clause, according to any one of the first clause to the eighth clause, the picture block is a prediction block, and
where obtaining the picture block based on the video data includes performing a prediction operation using the video data to obtain the prediction block.

In a tenth clause, according to the ninth clause, the prediction operation is inter-prediction or intra-prediction.

In an eleventh clause, according to any one of the first clause to the ninth clause, the picture block is a reference sample, and
the method further includes performing a prediction operation using the enhanced reference sample to obtain a prediction block.

In a twelfth clause, according to the eleventh clause, the prediction operation includes inter-prediction,
the reference sample corresponds to a first picture of the video data coded in the bitstream,
the prediction block corresponds to a second picture of the video data coded in the bitstream, the second picture being temporally spaced from the first picture, and
the first picture is coded at a lower resolution than the second picture in the bitstream.

In a thirteenth clause, according to any one of the first clause to the twelfth clause, the coding information indicates to apply a plurality of filters with a plurality of respective weighting maps to the picture block.

In a fourteenth clause, according to any one of the first clause to the thirteenth clause, the coding information indicates to use different weighting maps and/or signal enhancement filters for different picture blocks of a picture.

In a fifteenth clause, a non-transitory computer-readable medium comprising computer executable instructions stored thereon which when executed by a computing device cause the computing device to perform the method of any one of the first clause to the fourteenth clause.

In a sixteenth clause, a decoder is provided. The decoder includes:
one or more processors; and
a non-transitory computer-readable medium comprising computer executable instructions stored thereon which when executed by the one or more processors cause the one or more processors to perform the method of any one of the first clause to the fourteenth clause.

In a seventeenth clause, a method of processing video data performed by an encoder is provided, and the method includes:
obtaining original video data;
obtaining a downsampled version of the original video data;
obtaining a picture block based on the downsampled original video data;
upsampling the picture block;
obtaining a weighting map from the original video data;
defining a linear equation which represents a signal enhancement filter which calculates an enhanced picture block based on the weighting map, filter coefficients and the upsampled picture block;
applying least-squares optimization on the linear equation to obtain optimal filter coefficients for the weighting map;
obtaining an enhanced picture block by applying the signal enhancement filter using the optimal filter coefficients, together with the weighting map, to the upsampled picture block; and
encoding the downsampled original video data and coding information into a bitstream, the coding information comprising weighting map indication information indicating the weighting map and the calculated filter coefficients.

In an eighteenth clause, according to the seventeenth clause, the filter coefficients are calculated by calculating partial derivatives which are set to zero.

In a nineteenth clause, according to the eleventh clause or the eighteenth clause, the linear equation is brought into a form of a matrix vector multiplication, where the matrix is a symmetric matrix.

In a twentieth clause, according to the seventeenth clause, the upsampled picture block is an upsampled low resolution picture block which occurs after reference picture upsampling or multi-resolution coding.

In a twenty-first clause, according to any one of the seventeenth clause to the twentieth clause, the weighting map includes a scalar weighting map.

In a twenty-second clause, according to any one of the seventeenth clause to the twenty-first clause, the weighting map includes a Sobel magnitude map.

In a twenty-third clause, according to any one of the seventeenth clause to the twenty-second clause, the weighting map includes a plurality of weighting values respectively corresponding to values in the upsampled picture block.

In a twenty-fourth clause, according to any one of the seventeenth clause to the twenty-third clause, the weighting map indication information and the calculated filter coefficients are quantized and entropy encoded.

In a twenty-fifth clause, according to any one of the seventeenth clause to the twenty-fourth clause, the weighting map indication information and the calculated filter coefficients are explicitly signalled in the bitstream or are to be derived by a decoder from the video data in the bitstream.

In a twenty-sixth clause, according to any one of the seventeenth clause to the twenty-fifth clause, the weighting map is obtained by:
determining a weighting map function using weighting map indication information; and
calculating the weighting map by applying the weighting map function to the upsampled picture block.

In a twenty-seventh clause, according to any one of the seventeenth clause to the twenty-sixth clause, the weighting map indication information includes a weighting map identifier identifying one among a plurality of predefined weighting map functions.

In a twenty-eighth clause, according to the twenty-sixth clause or the twenty-seventh clause, the weighting map indication information includes parameters for the weighting map function.

In a twenty-ninth clause, according to any one of the seventeenth clause to the twenty-eighth clause, the picture block is a prediction block, and
obtaining the picture block based on the downsampled video data includes performing a prediction operation using the original video data to obtain the prediction block.

In a thirtieth clause, according to the twenty-ninth clause, the prediction operation is inter-prediction or intra-prediction.

In a thirty-first clause, according to any one of the seventeenth clause to the thirtieth clause, the picture block is a reference sample, and
the method further includes performing a prediction operation using the enhanced reference sample to obtain a prediction block.

In a thirty-second clause, according to the thirty-first clause, the prediction operation includes inter-prediction,
the reference sample corresponds to a first picture of the video data coded in the bitstream,
the prediction block corresponds to a second picture of the video data coded in the bitstream, the second picture being temporally spaced from the first picture, and
the first picture is coded at a lower resolution than the second picture in the bitstream.

In a thirty-third clause, according to the seventeenth clause to the thirty-second clause, the coding information indicates to apply a plurality of filters with a plurality of respective weighting maps to the picture block.

In a thirty-fourth clause, according to the seventeenth clause to the thirty-third clause, the coding information indicates to use different weighting maps and/or signal enhancement filters for different picture blocks of a picture.

In a thirty-fifth clause, a non-transitory computer-readable medium is provided. The non-transitory computer-readable medium includes computer executable instructions and a bitstream stored thereon, the instructions which, when executed by a processor of a computing device, cause the computing device to perform the method of any one of the seventeenth clause to the thirty-fourth clause to generate the bitstream.

In a thirty-sixth clause, an encoder is provided, and the encoder includes:
one or more processors; and
a non-transitory computer-readable medium comprising computer executable instructions stored thereon which when executed by the one or more processors cause the one or more processors to perform the method of any one of the seventeenth clause to the thirty-fourth clause.

Applying a signal enhancement filter with local weighting (weighting maps) and optimized filter coefficients increases coding performance. The local weighting can be applied to smoothly increase or decrease the strength of the filter at local regions. One could think of a weighting that increases the filter strength at edge regions but decreases it at regions where ringing would typically occur with the application of a signal enhancement filter. For example, in such a setup of weighting maps, a signal enhancement filter with filter coefficients optimized for a weighting map is determined which could amplify high frequency components without causing significant ringing. For example, in an image upsampling scenario, the amplification of high frequency components can be used to sharpen blurred edges. In some examples, adaptive filters can be used to deal with the different characteristics of coding artifacts and video content. The optimized filter coefficients are determined by using least-squares optimization. This can be done in a computationally efficient manner.

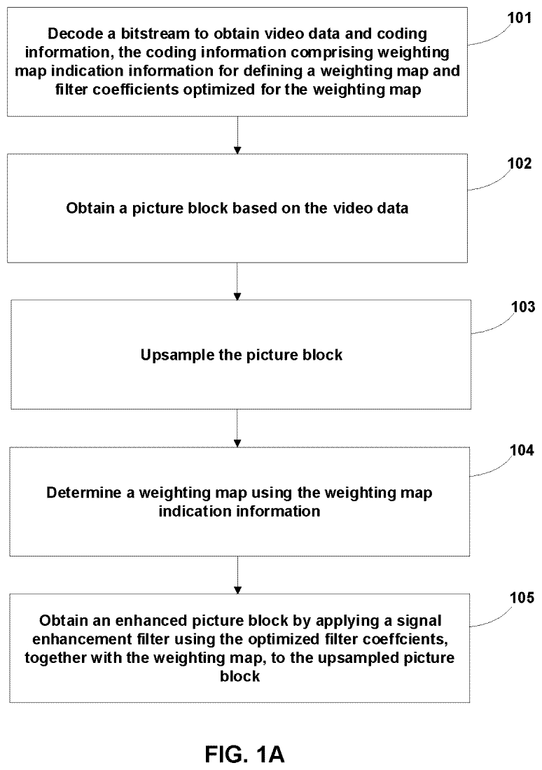

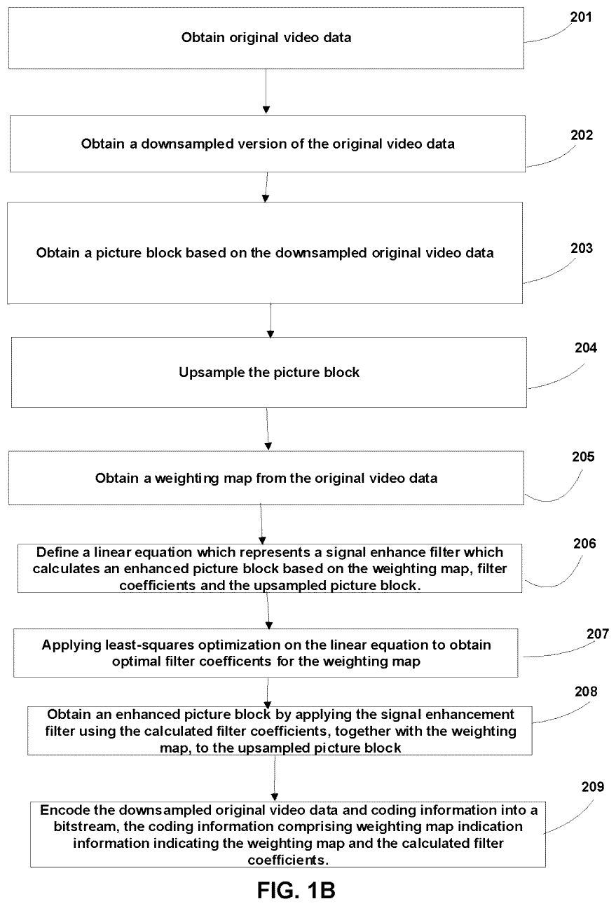

FIG. 1A shows a flowchart of the operations of a decoder 10 according to a first embodiment. FIG. 1B shows a flowchart of the operations of an encoder 20 according to the first embodiment.

The flowchart of FIG. 1A starts at step 101, in which the decoder 10 decodes a bitstream to obtain video data and coding information, the coding information comprising weighting map indication information and filter coefficients optimized for the weighting map.

At step 102, the decoder 10 obtains a picture block based on the video data. In this embodiment, the video data comprises a downsampled version of original video data. In the other words, the video data comprises a low-resolution version of original video data. Hence, step 102 involves obtaining the data corresponding to a picture block within the video data.

However, embodiments are not limited to this and the video data can comprise any data usable by the decoder 10 to obtain a picture block (e.g. by performing a prediction operation using the video data, such as intra-prediction or inter-prediction).

At step 103, the decoder 10 upsamples the picture block. In this embodiment, step 103 involves applying a set of multi-phase FIR-interpolation filters to reconstruct intensity values at fractional sample positions, so as to increase a resolution of the picture block. However, embodiments are not limited to this, and other methods of upsampling can be applied instead. In particular, there are many different methods that can be used for performing the interpolation. Basically, we have the problem in upsampling that fractional sample positions need to be interpolated. Those include bilinear interpolation, bicubic interpolation, nearest neighbour interpolation, and lanczos interpolation), to name a few.

In this embodiment, step 103 involves upsampling the picture block to the resolution of the original video data. However, embodiments are not limited to this and the picture block could instead be upsampled to a resolution lower than that of the original video data in other embodiments.

At step 104, the decoder 10 determines a weighting map using the weighting map indication information. In this embodiment, the weighting map indication information explicitly signals values of a weighting map with a resolution corresponding to that of the upsampled picture block. In an example, the upsampled picture block may have a size of 5×5, the weighting map indication information may comprise 25 values, each corresponding to a respective position in the 5×5 block. In this example, at step 104, the decoder 10 determines a weighting map with these 25 values.

However, embodiments of the application are not limited to this. For example, in some embodiments, the weighting map may have a smaller resolution than that of the upsampled picture block. In such cases, a single value in the weighting map may correspond to multiple values in the picture block. Furthermore, in other embodiments, the weighting map can be determined in other manners, as discussed further later.

At step 105, the decoder 10 obtains an enhanced picture block by applying a signal enhancement filter (SEF) using the optimized filter coefficients, together with the weighting map, to the upsampled picture block.

Hence, step 105 involves using a weighting map so that the signal enhancement filter is applied with different strengths to different regions of the upsampled picture block.

In this embodiment, the signal enhancement filter is a sharpening filter configured to sharpen blurred edges. However, embodiments are not limited to this. For example, in other embodiments, the coding information further indicates a particular signal enhancement filter and/or specific parameters of the signal enhancement filter to be used.

Following step 105, the enhanced picture block can then be used for any desired purpose. In one example, the decoder 10 then displays the enhanced picture block to a viewer. In another example, the decoder 10 stores the picture block for later use. In another example, the decoder 10 transmits the picture block to an external device for display.

A complementary method can be performed by the encoder 20 in order to encode the bitstream provided to the decoder 10. FIG. 1B shows a flowchart of the operations of the encoder 20 according to the first embodiment.

At step 201, the encoder 20 obtains original video data. For example, the encoder 20 may receive the original video data through a communication network (e.g. the internet) from an external server. However, there is no limit in the embodiments as to how the original video data is obtained.

At step 202, the encoder 20 obtains a downsampled version of the original video data. In this embodiment, step 202 involves the encoder 20 downsampling the original video data to obtain lower resolution video data. However, embodiments are not limited to this. For example, in some embodiments, the encoder 20 can instead simply receive both the original video data and downsampled video data from an external source, such as from an external server over a communication network (e.g. the internet).

At step 203, the encoder 20 obtains a picture block based on the downsampled original video data. In this embodiment, step 203 occurs in the same manner as step 102 of FIG. 1A. In other words, in this embodiment, the downsampled video data comprises a low-resolution version of the original video data. Hence, step 203 involves obtaining the data corresponding to a picture block within the video data.

However, embodiments are not limited to this. For example, in other embodiments, step 203 can instead involve performing a prediction operation using the downsampled video data, such as intra-prediction or inter-prediction, in order to obtain the picture block.

At step 204, the encoder 20 upsamples the picture block. Step 204 takes place in a corresponding manner to step 103 of FIG. 1A and a detailed description is omitted here for brevity. At step 205, the encoder 20 obtains a weighting map from the original video data.

At step 206, a linear equation which represents a signal enhance filter is defined which calculates an enhanced picture block based on the weighting map, filter coefficient and the upsampled picture block.

At step 207, a least-squares optimization is applied on the linear equation to obtain optimal filter coefficients for the weighting map.

At step 208, an enhanced picture block is obtained by applying a signal enhancement filter using the calculated filter coefficients, together with the weighting map, to the upsampled picture block.

At step 209, the downsampled original video data and coding information are encoded into a bitstream. The coding information comprises weighting map indication information which indicates the weighting map. The coding information further comprises the calculated filter coefficients.

As discussed above in relation to FIG. 1A, in this embodiment, a single predefined signal enhancement filter is used which is defined by filter coefficients which are calculated/optimzied by using least-square optimization (i.e. a filter that minimizes the squared error between the filtered signal and the ground-truth signal). Which leads to an optimal solution with regards to the filter coefficients is found, if a weighting map is given. Of course, in some embodiments, additional side constraints are set in the determination of the signal enhancement filter, such as filter shape, and filter coefficients that have to be equal.

However, while this embodiment has been discussed with reference to a signal enhancement filter based on the concept of a Wiener filter, embodiments are not limited in this respect, and other types of filter could be used instead, such as a filter based on a Sobel filter or unsharp masking filter as sharpening filters. Other non-linear options include bilateral filters and diffusion filters, as well as an Adaptive Loop Filter (ALF).

According to this method, the quality of upsampled pictures can be increased, in particular by reducing distortions caused by low-resolution coding. Those are the loss of high-frequency information and distortions caused by the video coding. This effect is achieved by optimizing filter coefficients for a given weighting map using least-square optimization.

In particular, the local weighting provided by the weighting map can be applied to smoothly increase or decrease the strength of the filter at local regions. In some examples, the weighting map could provide a weighting that increases the filter strength at edge regions but decreases it at regions where ringing would typically occur. With such a setup, an optimized filter could amplify high frequency components without causing significant ringing. This is especially helpful in an image upsampling scenario where the amplification of high frequency components is required to sharpen blurred edges.

In some examples, the signal enhancement filter can be applied to reduce edge blurring that has occurred in the upsampling operation. This method allows for the extraction of a suitable weighting map which, for example, extracts regions where ringing might occur and gives a low weight to those regions.

Ringing is usually generated by the quantization of high frequency components in the encoding process. Therefore, it can be assumed that ringing would, most frequently, occur in the surroundings of strong edges or corners as those usually lead to a frequency response containing high frequency components. In an example, an edge detector can be used to find the strongest edges in a picture. All samples that have a certain distance to the edge and are in the same block can be considered candidates for ringing. However, it will be appreciated that this is merely one example method of how ringing can be identified. Other methods can be used in addition, or instead.

Similarly, this filter can also be applied for other types of errors than edge blurring which makes this approach highly flexible.

In some examples, the optimisation discussed with reference to step 205 of FIG. 1B involves iterating between signal enhancing filter and weighting map function parameters. For example, starting parameters for a weighting map are set, and then the filter parameters are optimised based on the current weighting map. Then the weighting map parameters are optimised based on the found filter parameters and so on. Of course, this is a basic form of optimization procedure. In some cases, additional side constraint can be set, for example in order to not only determine the best filter and weighting map in terms of picture quality but also to have the coding rate as low as possible. This can be achieved by introducing those conditions in both of those individual optimizations and selecting the starting point for the next iteration under consideration of rate costs as well. More generally, it is possible to additionally introduce simplifications that limit the computational costs.

It will be appreciated that there are numerous methods for implementing the rate distortion optimisation discussed with reference to step 205 of FIG. 1B in variants of this embodiment. One example includes the optimization of a weighting map for each of the filter(s) according to the description for the next case. Thereby, the residual is recalculated based on the results of the previous filters. A second example is the joint optimization of the weighting map and signal enhancement filter. In this case, the optimization procedure heavily depends on the weighting map function. However, the most general optimization would include optimizing the signal enhancement filter for each possible weighting map and selecting the best option in terms of RD-costs. In order to solve this efficiently, simplifications may be applicable to find a sufficiently good solution. In case of a parametric weighting map that can be optimized linearly, it is possible to perform an iterative approach where the filter parameters are optimized given the current weighting map(s). Then, the weighting map parameters are optimized given the current filter parameters and so on. In other words, the signal enhancement filter is a filter that has one or more parameters, which depend on the weighting map. This may be useful as optimizing both jointly is computationally complex. Assuming that one of the components is fixed in each of the optimization steps acts to simplify the optimization of the remaining parameters.

In this embodiment, the weighting map provides linear weightings for the signal enhancement filter. However, embodiments are not limited to this, and in other embodiments, the values of the weighting map can instead modify the filtering procedure itself. For example, the signal enhancement filter could be parametric. In this case, the frequency response of an edge enhancement filter could be dependent on the local weighting map parameter. For example, the sigma value in unsharp masking (one type of sharpening filter) could be dependent on the weighting parameter. That means that the way that the filter works or more specifically, the function of the filter is parametric and not necessarily linearly dependent of the weighting map. Another example is a filter that does an edge thinning (sharpening) by warping the image. The strength of the warping could depend on the current weighting map value.

In this embodiment, the weighted signal enhancement filter is applied after the upsampling, and before any other operations. In particular, the signal enhancement filter is applied before the addition of a residual signal, for example. This location in the processing chain has shown to be effective. However, embodiments are not limited to this particular order, and a weighted signal enhancement filter may be applied at other processing steps additionally or alternatively in other embodiments.

In this embodiment, the signal enhancement filter is an optimized filter used to enhance the upsampled picture. However, embodiments are not limited to this. For example, in other embodiments, the coding information further indicates a particular signal enhancement filter and/or specific parameters of the signal enhancement filter to be used.

A first variant of the first embodiment will now be discussed, in which the weighting map indication information and weighting map determination are performed in a different manner to that discussed above.

As discussed above, in the first embodiment, the weighting map indication information explicitly signals values of a weighting map with a resolution corresponding to that of the upsampled picture block. However, embodiments are not limited to this. In a first variant of this embodiment, a weighting map function is pre-defined (e.g. stored in a memory at the decoder 10).

In this first variant, the weighting map indication information indicates parameters (or coefficients) of the pre-defined weighting map to be used. In this first variant, step 104 of FIG. 1A involves the decoder 10 applying the weighting map function (with the parameters encoded in the weighting map indication information in the bitstream) to the upsampled picture block in order to determine the weighting map.

One example of a weighting map function is the Sobel Magnitude Map, given by equation (1):

$$\frac{\sqrt{{{h}_{sobolx} ( x , y )}^{2} + {{h}_{soboly} ( x , y )}^{2}}}{a} \qquad ( 1 )$$

Where h_{sobelx} and h_{sobely} represent gradient components in the x and y directions at point (x, y) respectively, and a is a normalization factor.

Another example of a weight map function is the inverse of this function, as shown in equation (2):

$$1 - \frac{\sqrt{{{h}_{sobolx} ( x , y )}^{2} + {{h}_{soboly} ( x , y )}^{2}}}{a} \qquad ( 2 )$$

However, it will be appreciated that these are merely examples and other weighting map functions could be used in addition or instead.

Through this method of applying a single weighting map function to a picture block (comprising a plurality of sample values), the weighting map function is applied a plurality of times to a plurality of sample values of the picture block. This results in a weighting map that is calculated at the decoder 10 and depends on the values of the picture block.

As can be seen, in this variant, the weighting map calculation is performed at the decoder rather than the weighting map needing to be encoded at the bitstream. As a result, coding costs can be reduced. Furthermore, since the most suitable weighting map will depend on the picture content, the calculation of the weighting map by applying a function to the picture block itself, ensures that the most appropriate weighting map can be calculated by the decoder.

A second variant of the first embodiment will now be discussed, in which the coding information further comprises parameters to be used for the signal enhancement filter.

In a second variant of the first embodiment (which can, optionally, be combined with the first variant discussed above), the coding information further includes filter parameters of the signal enhancement filter. In other words, while this second variant still involves the use of a predefined signal enhancement filter as discussed above in relation to the first embodiment, the encoder 20 is able to indicate which parameters (or coefficients) should be used when applying the signal enhancement filter. In other words, the signal enhancement filter is adaptive.

In this variant, the filter parameters may be explicitly signaled, derived from the video data or the encoder 20 can indicate to re-use previously signaled coefficients.

In terms of the filter parameters being derived from the video data, if the video information in high resolution and in low-resolution is available, it is possible to estimate a filter that is approximately appropriate for the given data. This is the case for pictures directly after the resolution change to a lower resolution. However, in this case, it is useful to restrict the filter to regions where the motion between the high and low-resolution picture can be compensated and where it can be assumed that the object shape and orientation does not change significantly.

Moreover, there is the possibility to re-use previously decoded video/picture information to find more optimized filtering parameters. This refers to the idea of getting a more elaborate estimate on the location of edges or artifacts by using the information of multiple pictures. For example, if an edge in a previous picture is found and ringing artifacts occurring in a next picture that were not present previously, this information can be incorporated in the filter in order to optimize the filter such that those artifacts are not enhanced or, in the best case, removed. The use of temporal information aids this estimation and can lead to more precise estimates.

One option is to signal the coefficients of a previous filter are re-used entirely. A second option is to partially re-use information of previous filters. That could, for example, be weighting map parameters or a subset of the filter coefficients.

By only needing to signal filter coefficients (and/or merely an indication to re-use previous coefficients) and a weighting map, rather than fill details of a signal enhancement filter function, coding costs can be reduced.

In a third variant, the decoder 10 stores a filter buffer storing previously used signal enhancement filter parameters. Based on this, the encoder 20 has the option to simply include in the coding information an indication to use one or more previously used filter parameters rather than needing to include the specific parameter(s) themselves. Thereby, coding costs can be reduced.

Similarly, a fourth variant, a weighting map buffer is stored at the decoder 10, storing previously used weighting map function parameters. Based on this, the encoder 20 has the option to simply include in the coding information an indication to use one or more previously used weighting map function parameters rather than needing to include the specific parameter(s) themselves.

Of course, while these variants have been discussed above independently from one another, this is only for case of explanation. Any or all of these variants can be combined.

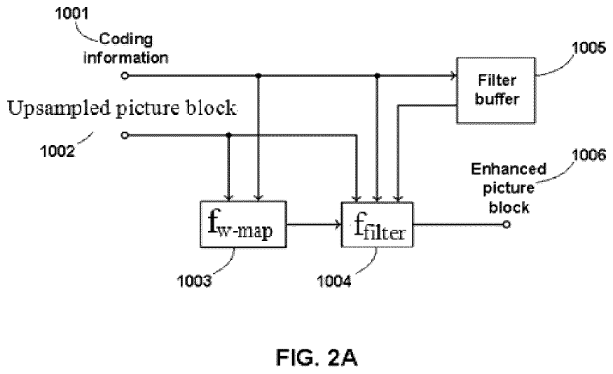

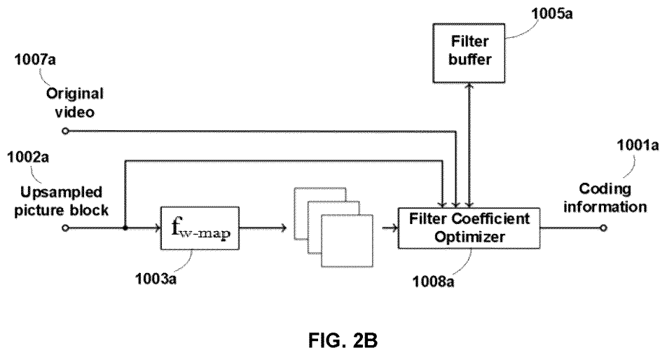

As an illustration of this, an example implementation of a combination of the first, second and third variants of the first embodiment will now be discussed with reference to FIG. 2A and FIG. 2B. FIG. 2A shows a block diagram illustrating example operations of the decoder 10, while FIG. 2B shows a block diagram illustrating example operations of the encoder 20.

As shown in FIG. 2A, the decoder 10 obtains coding information 1001 and an upsampled picture block 1002. The upsampled picture block 1002 is obtained in the manner discussed with reference to steps 102-103 of FIG. 1A.

As discussed above in relation to the first variant, the coding information 1001 comprises parameters to be used for the predefined weighting map function f_{w-map} 1003. With such parameters applied, the weighting map function f_{w-map} 1003 is then applied to the upsampled picture block 1002, so as to obtain a weighting map corresponding in resolution to that of the upsampled picture block 1002.

As discussed above in relation to the second and third variants, the coding information further comprises coefficients and/or an indication of previously used coefficients stored in the filter buffer 1005, to be used for the predefined signal enhancement filter f_{filter} 1004. The signal enhancement filter f_{filter} 1004, with these coefficients applied, is then applied to the upsampled picture block 1002, together with the weighting map, such that the signal enhancement filter f_{filter} 1004 is applied with different weights to different regions of the upsampled picture block 1002, so as to obtain the enhanced picture block 1006.

In this example, a complementary method is performed by the encoder 20, as shown in FIG. 2B. In a complementary manner to the block diagram of FIG. 2A, it can be seen that this involves the use of an original video (or picture block) 1007a, an upsampled picture block 1002a as inputs. This is followed by processing involving a weighting map function f_{w-map} 1003a, a filter buffer 1005a, and a filter coefficient optimizer 1008a resulting in the coding information 1001a. In more detail, the encoder 20 obtains the original video data 1007a (or just original picture block) and upsampled picture block 1002a as inputs, and performs a filter coefficient optimization in the optimizer 1008a. This filter coefficient calculation can be used in the adaptive loop filter. For deriving optimal filter coefficients, a least-squares optimization problem is formulated which is already known from Wiener-filters.

It is started from the following linear (signal enhancement filter) equation:

$$x ( \vec{n} ) = w ( \vec{n} ) + m ( \vec{n} ) {\sum }_{i = 0}^{N} {α}_{i} w ( \vec{n} - {f}_{offset} ( i ) ) \qquad ( 3 )$$

x denotes the filtered signal
w is defined as the input signal, which is, for example, an upsampled low-resolution picture block
m is a weighting map
αᵢ denote the filter coefficients to be optimized
\vec{n} is a vector that may have an arbitrary number of dimensions. In the case of scalar images, the vector would have two dimensions.

The function f_{offset} returns the filter offset given the filter element i. N is the number of

filter coefficients to be optimized.

A least-squares optimization can be done to calculate optimal filter coefficients αᵢ:

$$\begin{matrix}E [ {e}^{2} ( \vec{n} ) ] = E [ {( x ( \vec{n} ) - s ( \vec{n} ) )}^{2} ] \\ = E [ {x}^{2} ( \vec{n} ) ] + E [ {s}^{2} ( \vec{n} ) ] - 2 E [ x ( \vec{n} ) s ( \vec{n} ) ] \\ = E [ {( w ( \vec{n} ) + m ( \vec{n} ) {\sum }_{i = 0}^{N} {α}_{i} w ( \vec{n} - {f}_{offset} ( i ) ) )}^{2} ] + \\ E [ {s}^{2} ( \vec{n} ) ] - 2 E [ ( w ( \vec{n} ) + m ( \vec{n} ) {\sum }_{i = 0}^{N} ( {α}_{i} w ( \vec{n} - {f}_{offset} ( i ) ) ) ) s ( \vec{n} ) ]\end{matrix} \qquad ( 4 )$$

The optimal value for each filter coefficient αᵢ by calculating partial derivatives, which are then set to zero. This equation is solved and brought into a form of a matrix vector multiplication. The resulting matrix is a symmetric matrix which can be inverted efficiently. Therefore, the calculation of optimized filter coefficients according to this method is computationally efficient. The resulting equation system is denoted as follows:

$${\sum }_{j = 0}^{N} E [ m ( \vec{n} ) w ( \vec{n} - {f}_{offset} ( i ) ) m ( \vec{n} ) w ( \vec{n} - {f}_{offset} ( j ) ) ] {α}_{j} = E [ m ( \vec{n} ) w ( \vec{n} - {f}_{offset} ( i ) ) ( s ( \vec{n} ) - w ( \vec{n} ) ) ] \qquad ( 5 )$$

In some of the embodiments, the method is used for filtering upsampled pictures after reference picture resampling or in multi-resolution coding. In both applications, the filter could be applied after the upsampling step.

In an example, a first weighting map is a Sobel magnitude map which is defined as follows:

$${m}_{edge} ( \vec{n} ) = \frac{\sqrt{{[ ( {f}_{sobel , hor} * w ) ( \vec{n} ) ]}^{2} + {[ ( {f}_{sobel , ver} * w ) ( \vec{n} ) ]}^{2}}}{{s}^{}} \qquad ( 6 )$$

where * denotes the convolution operation.

In this example, a second weighting map is a complementary map.

Note that s is a normalization factor that is defined such that the sharpest possible edge would result in an edge value of one. Consequently, the values in m_{edge} are in the range [0,1] but might not cover the entire range depending on the context.

$${m}_{\text{?}} ( n ) = 1 - {m}_{edge} ( n )$$

$$\text{?} \text{indicates text missing or illegible when filed}$$

s is a scaling factor which depends on the bit-depth of the input signal.

Since there are two weighting maps, two signal enhancement filters are optimized such that calculated offsets from applying the filters to the upsampled image are added to get the filtered picture.

Through these optimized filter coefficients, the ability of the encoder to enhance picture quality is improved. In some of the embodiments, the signal enhancement filter is a linear filter represented as a linear equation, as the equation (3) above. In general, such a linear filter cannot be used to solve a non-linear problem. Given that the problems of edge sharpening and super-resolution for example are, in a general case, non-linear problems, this restricts the ability of such signal enhancement filters to solve these problems. However, by additionally making use of the described weighting map, this problem is overcome. In particular, even if the weighting map function used to calculate the weighting map is also linear, the combined use of two linear functions (i.e. weighting map function and signal enhancement filter function) in this way allows these non-linear problems to be solved.

It can be seen that these variants involve the use of weighting map calculation parameters and filter parameters of an adaptive signal enhancement filter. Thereby, filter coefficients are optimized to enhance the current picture block.

Further to the above discussion of the variants of this first embodiment, embodiments are not limited to the use of a single predefined weighting map function and/or a single predefined function. In some embodiments a plurality of predefined weighting map functions and/or signal enhancement filters are available (e.g. stored in a memory at the decoder 10). In such variants, in addition to the information discussed above in relation to the first and/or second variants, the coding information further comprises one or more identifiers identifying which weighing map function and/or signal enhancement filter should be applied.

Hence, in some embodiments, a plurality functions for the calculation of weighting maps are pre-defined and only calculation parameters and a weighting map identifier need to be signaled in the bitstream. Furthermore, in some embodiments, a plurality signal enhancement filters are pre-defined and only calculation parameters and a signal enhancement filter identifier need to be signaled in the bitstream.

While the first embodiment has been discussed with reference to a single signal enhancement filter and single weighting map, embodiments are not limited to this. In some variants of the first embodiment, a plurality of signal enhancement filters and weighting maps are used instead.

In once such variant, a plurality of signal enhancement filters with a plurality of respective weighting maps are applied to a single picture block. In other words, a plurality of signal enhancement filters with a plurality of respective weighting maps are applied to the same area of a picture. In this variant, signal enhancement filter identifiers are coded into the bitstream, together with weighting map indication information for each identified signal enhancement filter.

An overall summary of aspects of the first embodiment and applicable variants will now be provided. According to the application of a weighting map with a signal enhancement filter, it is possible to increase the quality of upsampled pictures. The application of the weighted signal enhancement filter before the addition of a residual signal (and before any other processing steps after upsampling) has shown to be an effective position in the processing chain. However, it is not a requirement and the weighted signal enhancement filter might also be applied at other processing steps.

As discussed above, an encoder side optimization based on a given weighting map is done to find the best filter setup. The encoder 20 needs to find the filter coefficients to be used for the current picture (or picture block).

In some aspects, filter coefficients are optimized. Each filter may be restricted to certain blocks and this can be considered in the optimization as well.

Filter coefficients may be explicitly signaled, derived from the video data, or the encoder 20 might indicate to re-use previously signaled filter coefficients. Moreover, there is the possibility to re-use previously decoded video information to find further optimized filter coefficients.

The signal enhancement filtering process is a two-step procedure. The first step is to determine the weighting map. In some aspects, the calculation of the weighting map can be done by any function that is applied to the upsampled picture block.

In some aspects, the encoder 20 may provide parametric information to the weighting map calculation and select the calculation parameters. This is advantageous as the most suitable weighting map depends on the image content. The result is a weighting map that provides spatial information on the filter weighting.

The weighting map is used in the next step. In this step, the picture block is filtered using the signal enhancement filter, where the local strength of the filtering operation is given by the weighting map. The exact implementation of the strength modification by the weighting map depends on the implementation and might, as an example, be a linear weighting of an offset computed by the filter or might modify the filtering procedure itself.

The application of a weighting signal enhancement filter in the manner described acts to reduce distortions caused by low-resolution video coding. Those are the loss of high-frequency information and distortions caused by the video coding. A default upsampling filter can be used for the initial resolution change, with the described weighted signal enhancement filter then applied independently afterwards. In other words, this weighted signal enhancement filter does not modify existing resampling (or upsampling) processes but instead adds/improves an enhancement step.

An overview of the steps involved in generating the enhanced upsampled picture block at the decoder side has been shown in FIG. 1A and FIG. 2A, for example. At the decoder side, the upsampled image (which was already upsampled by e.g. a default upsampling process) is obtained. Moreover, coding information is obtained which can specify aspects such as the mode of operation in some aspects.

In some aspects, the coding information contains local on-/off-flags for different filters, the weighting map functions and parameters for those functions. Moreover, an encoding of the filter coefficients is sent. In some aspects, this coding makes use of previously transmitted filter coefficients from the filter buffer to decrease coding costs.

In some aspects, after the filter parameters are decoded, the weighting map is calculated by applying the weighting map function to the picture block. The weighting map function may be any, not necessarily linear, function that maps the input picture block to an output picture block. The filter receives the weighting map and the upsampled image as input. The result of the filter operation is the enhanced picture block.

Depending on the configuration, in some aspects a plurality of filters is applied on a single picture. Those filters may be applied to partitions (or “blocks”) of the picture depending on rate-distortion criteria to account for different local image distortion characteristics. Moreover, multiple filters, with different weighting maps or parameters may be applied to the same image region (or “block” or “partition”) to reduce different kinds of artifacts in this image region.

Inputs to the optimization operation in the encoder 20 are the upsampled picture block (or video) and the original/ground-truth picture block (or video). In some aspects, the optimizer generates optimized filter coefficients from the upsampled picture block (or video) for a given weighting map using a least-squares optimization.

In some aspects, a plurality of sets of weighting maps are determined, and a respective set of applied signal enhancement filters and picture partitions (to partition the picture into a plurality of blocks) is chosen by the decoder 10.

Moreover, in some aspects, the signal enhancement filter parameters are optimized. In doing so, re-using parameters from previous configurations in the filter buffer can optionally be considered. There are several options to re-use filter parameters. One option is to signal the parameters of a previous filter are re-used entirely. A second option is to partially re-use information of previous filters. That could, for example, be weighting map parameters or a subset of the filter coefficients.

An exemplary implementation of the first embodiment involves using linear filters. In this case, the encoder 20 determines the filter coefficients by a least squares optimization. In doing so, it is assumed that the weighting is applied by multiplying the weighting map to the filtered image. Moreover, it is assumed that the output is computed by adding the weighted and filtered picture to the input picture. Note that, even in this case where a linear filter is applied to the upsampled picture, the overall system is capable of solving non-linear problems due to the multiplication with the weighting map.

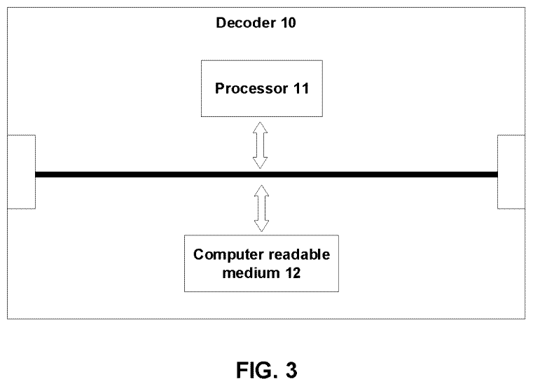

FIG. 3 shows a schematic illustration of a decoder 10 according to an embodiment. Specifically, FIG. 3 shows a schematic illustration of a decoder 10 configured to perform any of the decoder methods discussed herein. Such detailed descriptions thereof are omitted here for brevity.

As shown in FIG. 3, the decoder 10 comprises a processor 11 and a non-transitory computer readable medium 12. The processor 11 and the computer readable medium 12 may be connected via a bus system. The non-transitory computer readable medium is configured to store programs, instructions or codes. The processor 11 is configured to execute the programs, the instructions or the codes in the non-transitory computer readable medium 12 so as to complete the operations in the decoder method embodiments herein.

Hence, in embodiments, the non-transitory computer readable medium 12 is configured to store a computer program capable of being run in the processor 11, and the processor 11 is configured to run the computer program to perform steps in any of the decoder methods discussed herein.

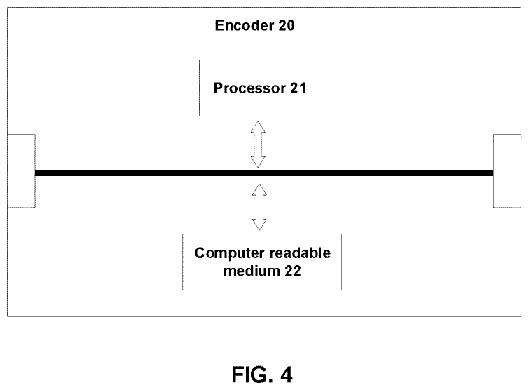

FIG. 4 shows a schematic illustration of an encoder 20 according to an embodiment. Specifically, FIG. 4 shows a schematic illustration of an encoder 20 configured to perform any of the encoder methods discussed herein. Such detailed descriptions thereof are omitted here for brevity.

As shown in FIG. 4, the encoder 20 comprises a processor 21 and a non-transitory computer readable medium 22. The processor 21 and the non-transitory computer readable medium 22 may be connected via a bus system. The non-transitory computer readable medium is configured to store programs, instructions or codes. The processor 21 is configured to execute the programs, the instructions or the codes in the non-transitory computer readable medium 22 so as to complete the operations in the encoder method embodiments herein.

Hence, in embodiments, the non-transitory computer readable medium 22 is configured to store a computer program capable of being run in the processor 21, and the processor 21 is configured to run the computer program to perform steps in any of the encoder methods discussed herein.

As discussed in detail above, embodiments provide an in-loop filtering process for the refinement of upsampled videos, where a local weighting map is used in the filtering process.

In some embodiments a plurality of filters are applied with different weighting maps to the same picture.

In some embodiments a plurality of filters are applied for different regions of the picture.

In some embodiments a plurality functions for the calculation of weighting maps is pre-defined and only calculation parameters and a weighting map identifier need to be signaled.

In some embodiments the signal enhancement filter is applied after the interpolation filter in reference picture resampling.

In some embodiments the signal enhancement filter is applied before an upsampled low-resolution picture is presented to a viewer.

In some embodiments the signal enhancement filter is applied after the interpolation filter in multi-resolution coding.

The use of signal enhancement filters is not restricted to these described applications. They only provide an overview of application areas that are well suited. In general, the signal enhancement filters can be applied in every signal processing setup that requires an enhancement of a signal and which has characteristics that can be effectively exploited by a weighted filtering setup. This is not restricted to the domain of video coding/processing but may also be applied e.g. to image coding/processing or audio coding/processing.

Embodiments of the present disclosure can also provide a non-transitory computer-readable medium having computer-executable instructions to cause one or more processors of a computing device to carry out the method of any of the embodiments of the present disclosure.

Examples of computer-readable media include both volatile and non-volatile media, removable and non-removable media, and include, but are not limited to: solid state memories; removable disks; hard disk drives; magnetic media; and optical disks. In general, the computer-readable media include any type of medium suitable for storing, encoding, or carrying a series of instructions executable by one or more computers to perform any one or more of the processes and features described herein.

It will be appreciated that the functionality of each of the components discussed can be combined in a number of ways other than those discussed in the foregoing description. For example, in some embodiments, the functionality of more than one of the discussed devices can be incorporated into a single device. In other embodiments, the functionality of at least one of the devices discussed can be split into a plurality of separate (or distributed) devices.

Conditional language such as “may”, is generally used to indicate that features/steps are used in a particular embodiment, but that alternative embodiments may include alternative features, or omit such features altogether.

Furthermore, the method steps are not limited to the particular sequences described, and it will be appreciated that these can be combined in any other appropriate sequences. In some embodiments, this may result in some method steps being performed in parallel. In addition, in some embodiments, particular method steps may also be omitted altogether.

While certain embodiments have been discussed, it will be appreciated that these are used to exemplify the overall teaching of the present disclosure, and that various modifications can be made without departing from the scope of the present disclosure. The scope of the present disclosure should is to be construed in accordance with the appended claims and any equivalents thereof.

Many further variations and modifications will suggest themselves to those versed in the art upon making reference to the foregoing illustrative embodiments, which are given by way of example only, and which are not intended to limit the scope of the present disclosure, that being determined by the appended claims.

What is claimed is:

1. A method of processing video data, performed by a decoder, the method comprising:
decoding a bitstream to obtain video data and coding information, the coding information comprising weighting map indication information for defining a weighting map and filter coefficients optimized for the weighting map;
obtaining a picture block based on the video data;
upsampling the picture block;
determining the weighting map using the weighting map indication information; and
obtaining an enhanced picture block by applying a signal enhancement filter using the filter coefficients, together with the weighting map, to the upsampled picture block.

2. The method of claim 1, wherein the weighting map comprises a scalar weighting map.

3. The method of claim 1, wherein the weighting map comprises a Sobel magnitude map.

4. The method of claim 1, wherein the weighting map comprises a plurality of weighting values respectively corresponding to values in the upsampled picture block.

5. The method of claim 1, wherein signal enhancement filter indication information indicates to re-use one or more filter coefficients stored in a filter buffer of the decoder for the signal enhancement filter.

6. The method of claim 1, wherein determining the weighting map using the weighting map indication information comprises:
determining a weighting map function using the weighting map indication information; and
calculating the weighting map by applying the weighting map function to the upsampled picture block.

7. The method of claim 6, wherein the weighting map indication information comprises a weighting map identifier identifying one among a plurality of predefined weighting map functions.

8. The method of claim 6, wherein the weighting map indication information comprises parameters for the weighting map function.

9. The method of claim 1, wherein the picture block is a prediction block, and wherein obtaining the picture block based on the video data comprises performing a prediction operation using the video data to obtain the prediction block.

10. The method of claim 9, wherein the prediction operation is inter-prediction or intra-prediction.

11. The method of claim 1, wherein the picture block is a reference sample, and
the method further comprises performing a prediction operation using the enhanced reference sample to obtain a prediction block.

12. The method of claim 11, wherein the prediction operation comprises inter-prediction,
the reference sample corresponds to a first picture of the video data coded in the bitstream,
the prediction block corresponds to a second picture of the video data coded in the bitstream, the second picture being temporally spaced from the first picture, and
the first picture is coded at a lower resolution than the second picture in the bitstream.

13. The method of claim 1, wherein the coding information indicates to apply a plurality of filters with a plurality of respective weighting maps to the picture block.

14. The method of claim 1, wherein the coding information indicates to use different weighting maps and/or signal enhancement filters for different picture blocks of a picture.

15. A decoder, comprising
one or more processors; and
a non-transitory computer-readable medium comprising computer executable instructions stored thereon which when executed by the one or more processors cause the one or more processors to perform:
decoding a bitstream to obtain video data and coding information, the coding information comprising weighting map indication information for defining a weighting map and filter coefficients optimized for the weighting map;
obtaining a picture block based on the video data;
upsampling the picture block;
determining the weighting map using the weighting map indication information; and
obtaining an enhanced picture block by applying a signal enhancement filter using the filter coefficients, together with the weighting map, to the upsampled picture block.

16. A method of processing video data, performed by an encoder, the method comprising:
obtaining original video data;
obtaining a downsampled version of the original video data;
obtaining a picture block based on the downsampled original video data;
upsampling the picture block;
obtaining a weighting map from the original video data;
defining a linear equation which represents a signal enhancement filter which calculates an enhanced picture block based on the weighting map, filter coefficients and the upsampled picture block;
applying least-squares optimization on the linear equation to obtain optimal filter coefficients for the weighting map;
obtaining an enhanced picture block by applying the signal enhancement filter using the optimal filter coefficients, together with the weighting map, to the upsampled picture block; and
encoding the downsampled original video data and coding information into a bitstream, the coding information comprising weighting map indication information indicating the weighting map and the calculated filter coefficients.

17. The method of claim 16, wherein the filter coefficients are calculated by calculating partial derivatives which are set to zero; and
the linear equation is brought into a form of a matrix vector multiplication, wherein the matrix is a symmetric matrix.

18. The method of claim 16, wherein the upsampled picture block is an upsampled low resolution picture block which occurs after reference picture upsampling or multi-resolution coding;
wherein the weighting map comprises a scalar weighting map; or
the weighting map comprises a Sobel magnitude map; or
the weighting map comprises a plurality of weighting values respectively corresponding to values in the upsampled picture block.

19. The method of claim 16, wherein the weighting map indication information and the calculated filter coefficients are quantized and entropy encoded; and
the weighting map indication information and the calculated filter coefficients are explicitly signalled in the bitstream or are to be derived by a decoder from the video data in the bitstream;
wherein the weighting map is obtained by:
determining a weighting map function using weighting map indication information; and
calculating the weighting map by applying the weighting map function to the upsampled picture block.

20. A non-transitory computer-readable medium, comprising computer executable instructions and a bitstream stored thereon, and the instructions which, when executed by a processor of a computing device, cause the computing device to perform the method of claim 16 to generate the bitstream.
